(19) United States
(12) Patent Application Publication
(10) Pub. No.: US 2023/0356312 A1
(43) Pub. Date: Nov. 9, 2023

(54) HAND ABRADING TOOL WITH REVERSIBLE WORKING ENDS AND SURFACES

(71) Applicant: David WILKINSON, Casula (AU)

(72) Inventor: David WILKINSON, Casula (AU)

(21) Appl. No.: 18/246,726

(22) PCT Filed: Mar. 4, 2021
(86) PCT No.: PCT/AU2021/000023

§ 371 Date: Mar. 27, 2023

(30) Foreign Application Priority Data
Mar. 4, 2020 (AU) 2020900646

(51) Int. Cl. B23D 67/12; B23D 71/06; B25G 1/06; B25G 1/08

(52) U.S. Cl. CPC B23D 67/12; B23D 71/06; B25G 1/06; B25G 1/08

(57) ABSTRACT

A hand operated filing tool comprising a gripping handle, an elongated shaft extending through the handle. The shaft has a first working end including at least one filing surface along at least part of the length of the first working end of the shaft and a second working end including at least one filing surface along at least part of the length of the second working end of the shaft. The shaft and handle arranged to allow the handle to move between the working ends of the shaft, thereby allowing user selection of the at least one filing surface at either the first or second working ends.

### BACKGROUND

The present invention relates to improvements in hand tools and particularly to a file of the type used for filing, abrading, trimming, grinding and the like and which has an adjustable handle which allows a user to select different working surfaces at the ends of or along the length of a shaft of the tool.

The invention further relates to a hand tool which includes at least one file surface and an adjustable handle which allows a user to optionally select either end of the tool for a leading end working surface and optionally induce relative rotation between a file shaft and handle. More particularly the present invention relates to a file tool which has improved functionality, is convenient to use and which can be transitioned between working surfaces along the length of the tool and which allows a user to select from multiple filing grade surfaces in the one tool. The invention further relates to a hand filing tool which has increased versatility and thus increased user options in the one tool.

### PRIOR ART

There are in existence a variety of hand tools which are each designed for performance of specific hand operated functions. Among the commonly used hand operated work tools is a file which is normally used for such functions collectively known as filing and including abrading, trimming, grinding, sanding, finishing and smoothing off etc.

In the past, various file types have been provided. These are generally elongated metallic tools which have at least one abrading surface. The abrading surface of each file and its shape and configuration are tailored to suit the type of filing job required. Some have handles and some do not. They come in a variety of lengths and shapes primarily dictated by the filing functions they perform. In the past, one tool is designed to perform one or two grades of filing. In this regard, a flat file will normally include one grade of filing surface on one side and another grade of filing surface on the other side. These files may also have an abrading surface of the same or different texture grades along each of usually two side edges. A circular file will normally have just one grade of filing surface.

In the past, file tool users are forced to purchase multiple files if the user wishes to perform multiple grades of filing. Grades of filing include at one extreme, a very rough file surface and at the other extreme, a very fine filing surface. Many grades exist therebetween. Typically, in a tool box, a user will have multiple file types, grades and sizes for job selections. Establishing a kit of files takes up space and is relatively expensive.

Over the years, various types of ‘all in one’ combination hand tools have been provided using a handle for holding a shaft having different working ends, tools, bits or tool drives on each end. Some tools have had a combination of tools of different types or sizes. Other tools have multiple functionality involving attachments or repositioning of articulating parts. Known combination hand tools have been provided to enable a user to select different working ends removing the need to carry multiple tools for different work purposes.

For example, the prior art also discloses a variety of pliers and related hand tools such as those disclosed in CN204600599, U.S. Pat. No. 9,623,546 and US2013291692 which are incorporated by reference herein. CN204600599 discloses a utility model for a pliers which include a pair of articulated handles, rotatable around a screw. The handle front (distal) end is provided with detachable pliers head, and with a locking mechanical system between a pair of handles. The utility model discloses that the head of pliers is removable.

In another example of the know art, U.S. Pat. No. 9,623,546 discloses a multipurpose hand held tool which includes a multi layered plier head which includes addons such as a flashlight which allows the tool to perform multiple tasks. US2013291692 discloses pliers that include a jaw member which is removably coupled to a head of the pliers. The jaw member includes a grip surface and a flange including an aperture. The jaw member is slidable along the jaw surface of the head from the first longitudinal side toward the second longitudinal side to uncouple the jaw member.

In another example of a tool that can be altered to perform a different function, U.S. Pat. No. 4,779,493 discloses a combination pocket tool which has a shank and a handle. The shank has a tool at one end and a tool drive at the other end. The handle has a steel sleeve embedded within a hollow cavity. A first detent on the tool drive secures the tool or the tool drive within the cavity of the handle. A second detent on the tool drive assists in securing the tool drive within the cavity or secures a detachable tool to the tool drive. In this case the handle must be removed to expose the second alternative working end then replaced onto the shank.

Among the known multifunction tools is one having a handle and a shaft that has working ends, such as a screwdriver blade integrally formed at one end and an alternative profile at an opposite end. One such device has been disclosed by the same applicant in PCT/AU2011/000642 publication No. WO2011/146997. Another working formation may be integrally formed on the opposite end of the shaft. A detent located on the shaft, secures the tool or the tool drive within a cavity in the handle. A second detent, on the tool drive, helps to secure the tool drive within the handle when the tool is in use. The shaft is interchangeably positionable within the handle in either one of a first position where a first end of the shaft locates within the handle and a second end of said shaft projects outwardly from the handle and a second position where a second end of the shaft locates within the handle and the first end of the shaft projects outwardly from the handle. The aforesaid describes some of the known dual or multifunction tools.

Known filing tools are generally presented to the consumer with a fixed handle and an abrasive surface on one or two sides. These tools are either provided as a single tool or in a kit of like tools of different sizes and/or abrasive grades. Some economies are enabled by sale of these tools in kit form, but whether a consumer purchases individual tools, or a kit of such tools, that can prove to be expensive and require significant storage space to accommodate the various filing tools.

There is a need to provide improvements in the known hand filing tools to increase efficiency of operation and to provide more convenient options for users. More particularly there is a need to increase the versatility of hand operated tools such as but not limited to filing tools, so that working ends of the tools and working surfaces can be optionally selected by a user and which are interchangeable and self-contained within the body of the tool to reduce the number of tools required by a user. There is also a need to provide an alternative filing tool which is economic, saves storage space in tool kits and other storage environments and has increased versatility and user options.

### INVENTION

The present invention seeks to ameliorate the above disadvantages of the prior art filing tools by providing an alternative and improved hand filing tool which is more convenient to use and improves the versatility of known hand filing tools and particularly those which include a hand operated gripping handle. The invention further provides a versatile hand filing tool which has improved functionality and which has self-contained user selections, including, but not limited to, flat, circular, concave, crescent, square, rectangular, triangular full or part working surfaces or any combinations of the aforesaid shapes and textures and grades.

In its broadest form the present invention comprises:
a hand operated filing tool comprising a gripping handle, an elongated shaft extending through the handle; the shaft having a first working end including at least one filing surface along at least part of the length of the first working end of the shaft and a second working end including at least one filing surface along at least part of the length of the second end of the shaft; the shaft and handle arranged to allow the handle to move between the working ends of the shaft, thereby allowing user selection of the at least one filing surface at either the first or second working ends.

According to a preferred embodiment, a user can select either working end. Working ends include a working filing surface provided along part or all surfaces of the shaft increasing user options. The shaft can be rotated, preferably through 90 degree increments, relative to the handle to present optimal attitudes of working surfaces for presentations to materials of which filing or related work is to be performed by the user. According to one embodiment there could be up to 8 or more working surfaces which has the same or different grades. Also, the handle according to one embodiment can be released from the shaft and repositioned on the shaft at the same or opposite end of the shaft.

Selected rotations of the shaft to alternative attitudes, optimise presentation of work surfaces to materials on which work is to be performed. Throughout the specification a reference to a working end can be taken to include a reference to a working surface provided on one or all faces of a shaft. This includes full or part working surfaces of the same or different grades, along any face of the shaft extending from the handle to the distal extremity and includes the edge tip.

According to one embodiment, the filing surface has a rough texture/grade. According to one embodiment, the filing surface has a fine texture/grade. According to one embodiment, the shaft is flat having opposing filing surfaces. Alternatively, the shaft is circular and has a circular filing surface. Each working end extends from a free end of the shaft towards a transverse midline of the shaft but may be abbreviated or intermittent along the surface of the shaft.

The filing surfaces at the first and second ends may be the same or different textures. According to an alternative embodiment, the filing surface at the first end has a different texture from the texture of the filing surface at the second end.

In another broad form the present invention comprises:
a hand operated filing tool of the type comprising a gripping handle, an elongated shaft extending through the handle and having a first working end and a second working end; the first working end including a filing surface along at least part of the length of the shaft and the second working end including a filing surface along at least part of the length of the shaft; the shaft and handle arranged to allow the handle to move/slide along the shaft between the first and second working ends of the shaft, thereby allowing user selection of either the first or second working ends; the tool further comprising an arrest mechanism which retains the travel of the shaft relative said handle at a predetermined limit position to enable locking of the shaft against said handle.

According to a preferred embodiment the shaft includes along at least one edge a first formation which co-operates with a second formation associated with the handle to enable setting of the shaft in said limit position. According to one embodiment the arrest mechanism is provided by a shoulder region which limits travel of the handle along the shaft to a predetermined stop position. According to one embodiment, the handle can be released from the shaft and repositioned on the shaft either in the same or opposite orientation.

According to a preferred embodiment the first formation comprises a recess along at least part of the length of one side of the shaft. A corresponding second formation on the handle engages the recess. Preferably the shaft has two elongated recesses one either said of the shaft. The handle includes opposing curved or concave second formations which co-operate with the first formation in the shaft. Preferably the first formation has at or near each end a shoulder which provides an abutment limiting travel of the shaft to said limit position.

According to a preferred embodiment the handle includes at each end an end cap which is rotatable to close a through passage to prevent extension of said shaft beyond said handle when selecting said for or second working positions. Preferably there are at least two filing surfaces of the same of different grade. The file shaft may be arranged such that a plurality of abrading surfaces are available to a user.

Although the shaft is described herein as having generally a flat abrading surface or surfaces, it will be appreciated that, the hand tool described can be arranged in a variety of permutations and combinations of features. For example the shaft can be provided as, but not limited to, when viewed in cross section, circular, concave, crescent shaped, square, triangular, rectangular, hexagonal, polygonal, with each surface presented having a filing surface of one or multiple grades along at least part of the length of the working end of the shaft. In each case the handle is according to one embodiment, provided with a formation of longitudinal extent which engages a corresponding formation provided on the shaft to guide the shaft along the handle and to provide an arrest to limit the travel of the shaft at a predetermined position relative to the handle.

According to one embodiment, the formations are provided by a recess on the shaft and a corresponding protrusion along the handle which engage in male female inter-fitting. In an alternative embodiment, the protrusion may be provided on the shaft and a recess provided on the handle. The interacting formations also include at last one shoulder formations which provides an abutment to limit the travel of the handle along the shaft.

A keyway is provided in the handle to generally match the adopted profile of the shaft. According to one embodiment, at each end of the handle, is provided a rotatable closure which on rotation misaligns the keyway and shaft profile and contributes to preventing the shaft from exiting the keyway. It will be appreciated that a reference to a keyway can be taken to also mean a generic reference to a slot, opening abbreviation, guide, and the like.

For convenience, the description herein refers to grip operated hand tools and more specifically to a filing tool which has an abrasive surface of at least one textured surface. Objects of this invention, which will become more apparent upon consideration of the attached description and drawings are provided in accordance with the preferred embodiment of this invention illustrated by a non-limiting assembly which enables convenient selection of filing surfaces at each said working ends. It will however be appreciated that different filing textures/grades and profiles at working ends can be selected by a user for different filing actions required by the tool.

Although the invention will be predominantly described with reference to its application to a planar shaft, it will be recognised by persons skilled in the art that the invention has potentially a wide variety of cross sectional shapes for the shaft such as but not limited to square, rectangular, triangular, circular, elliptical, crescent shaped, U shaped or L shaped. The invention can be adapted as a child's toy manufactured from such materials as but not limited to plastics and polystyrene with similar characteristics to the working tool.

The present invention provides a useful alternative to the known prior art and addresses the limitations of the known art and provides a useful alternative. The foregoing and other objects and advantages will appear from the description to follow. In the description reference is made to the accompanying representations, which forms a part hereof, and in which is shown by way of illustration specific embodiments in which the invention may be practiced.

These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. The following detailed description is, therefore, not to be taken in a limiting sense, and the scope of the present invention is best defined by the appended claims.

### BRIEF SUMMARY OF DRAWINGS

The invention will now be described in more detail according to a preferred but non limiting embodiment and with reference to the accompanying illustrations.

FIG. 1 shows a top perspective view of the hand tool according to a preferred embodiment.

FIG. 2 shows a bottom perspective view of the tool of FIG. 1.

FIG. 3 shows a side elevation of the hand tool of FIG. 1.

FIG. 4 shows to first end elevation view of the hand tool of FIG. 1.

FIG. 5 shows a second end elevation of the tool of FIG. 1.

FIG. 6 shows an enlarged elevation view of the hand tool.

FIG. 7 shows a cross sectional elevation view of the elevation view of FIG. 6 taken across A-A.

FIG. 8 shows a long sectional elevation taken along B-B.

FIG. 9 shows an enlarged end view of FIG. 5 at the point of entry of shaft into handle.

FIG. 10 shows an enlarged end view of FIG. 4 and a first end elevation view of FIG. 8.

### DETAILED DESCRIPTION

It will be convenient to hereinafter describe the invention in relation to its application as a reversible filing tool but it will be appreciated that the invention is not limited to that application and may be adapted to alternative constructions allowing functions such as but not limited to abrasion and sanding. The invention has been described with reference to a reversible shaft comprising two opposing filing surfaces but it will be appreciated that this is one shaft profile selected from the other shaft profile options referred to herein. The assembly described herein has advantages over the known art including improved efficiency and versatility.

Throughout the description, a reference to a filing surface can be taken to include a reference to but not restricted to, an abrading or abrasive surface, sanding surface, roughened surface, and includes such surfaces which are described as single cut, double cut, fine, smooth, bastard cut, crossed. A reference to a filing surface can also be taken to include any surface which has other than a smooth texture and is capable of marking, shaping, eroding or abrading another surface. Throughout the description, a reference to a recess can be taken to include a reference to a slot, groove, indent, channel and a reference to any one of those terms can be taken as a reference to any one of the other terms. A reference to a filing surface grade relates to the roughness or fineness of the filing surface profile. Objects of this invention, which will become more apparent upon consideration of the attached description and drawings are provided in accordance with the preferred embodiment of this invention illustrated by a non-limiting assembly which enables convenient selection of filing surfaces at each said working ends. It will however be appreciated that different filing textures/grades and profiles at working ends can be selected by a user for different filing actions required by the tool. A reference to a working end can be taken to include a reference to the distance or a part of that distance between the distal end of the shaft and the location where the shaft enter the handle

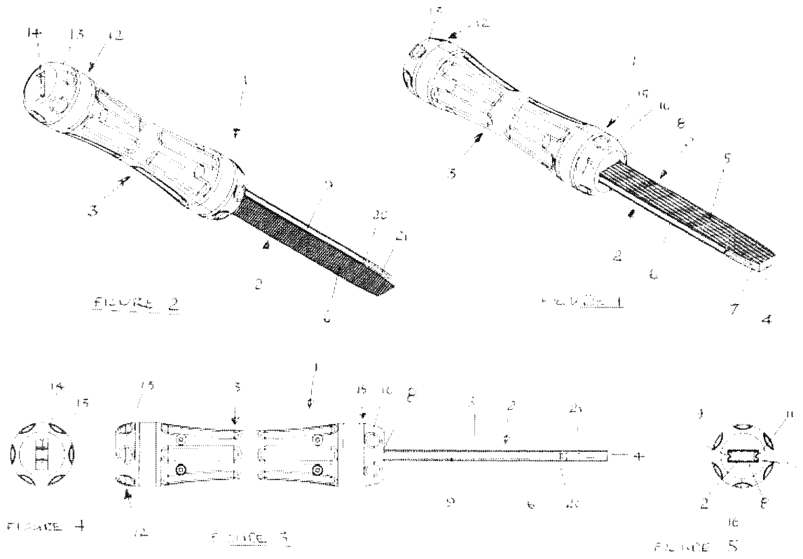

FIG. 1 shows a top perspective view of the hand tool 1 according to a preferred embodiment. Referring to FIG. 1 there is shown hand tool 1 comprising an elongated shaft 2 and gripping handle 3 which is capable of sliding along the length of the shaft 2. Handle 3 is arranged to facilitate user ergonomics, the contours of which may be adjusted/adapted to suit hand gripping comfort and gripability. Preferably, handle 3 includes a medially located waist region and protrusions and/or recesses/indentations which improve gripability. It will be appreciated that the geometry, texture, materials of construction, shape and configuration of the handle can be adjusted to suit user requirements. Shaft 2 as shown includes a first end 4 and is generally planar having upper surface 5 and lower surface 6. Each of surfaces 5 and 6 are abrasive and enable selective use for filing, sanding or the like. Shaft 2 includes an edge 7 having a generally concave recess 9 extending lengthwise along each edge. Shaft 2 further comprises an edge 10 having a concave recess 11 also extending lengthwise along edge 10 (see FIG. 5). Although recesses 9 and 11 are shown as concave, it will be appreciated to persons skilled in the art that a recess having alternative profiles are feasible such as but not limited to convex, square, rectangular, triangular, elliptical, semi-circular, polygonal, with any of the above male or female. Recesses 9 and 11 assist in guidance of the shaft as it is urged longitudinally relative to handle 3.

FIG. 2 shows with corresponding numbering, a bottom perspective view of the hand tool 1 of FIG. 1. End 12 of handle 3 includes an end cap closure 13 which is rotatable relative to handle 3. As shown in FIG. 3 closure 13 includes an opening 14 to through passage 8 (see FIG. 1). Opening 14 as shown is disposed normally to the plane of shaft 2. This is achieved by rotation of closure 13 so that shaft 2 and opening 14 are misaligned to avoid unwanted penetration of shaft 2 through opening 14 of closure 13 during use of hand tool 1.

It will be appreciated that the shaft 2 may also be rotatable axially at least 90 degrees, relative to the handle 3 or the handle 3 may be rotated axially relative to the shaft 2. Specifically the shaft can not only be slid from end to end, exposing a working filing surface, but rotated while each end is exposed. This allows a user to exploit functionality of both sides of the work surfaces and also allows a user to orientate edge surfaces of the abrading surfaces of shaft 2, thereby allowing a user to more conveniently use those edges.

A similar arrangement is provided at end 15 of handle 3 which includes closure 16 and which receives shaft 2 via through passage 8. Recess 9 extends to a shoulder 20 which is slightly elevated above the invert of recess 9 and provides an abutment which limits travel of handle 3. Recess 9 ends at shoulder 20 and morphs into tapered recess 21. A similar arrangement (obscured) is provided at the opposite end of recess 9 and 11 (see FIG. 5) of shaft 2.

According to a preferred embodiment the shaft includes along at least one edge a curved recess which co-operates with a guide associated with the handle to enable setting of the shaft in a limit position. According to one embodiment the arrest mechanism is provided by a shoulder as described earlier which limits travel of the handle along the shaft to a predetermined stop position.

According to a preferred embodiment the first formation comprises a recess along at least part of the length of one side of the shaft. A corresponding second formation on the handle engages the recess. Preferably the shaft has two elongated recesses one either said of the shaft extending for a substantial part of the length of the shaft. According to a preferred embodiment the shaft includes at least two filing surfaces of the same or different grade. The file shaft may be arranged such that a plurality of abrading surfaces are available to a user.

It will be appreciated that, the hand tool described can be arranged in a variety of permutations and combinations of features. The shaft can be a shape other than planar and when viewed in cross section, circular, crescent shaped, square, triangular, rectangular, hexagonal, polygonal. Depending upon the profile shape selected, the elongated guide recess will be place at a suitable location to accommodate corresponding parts of the handle.

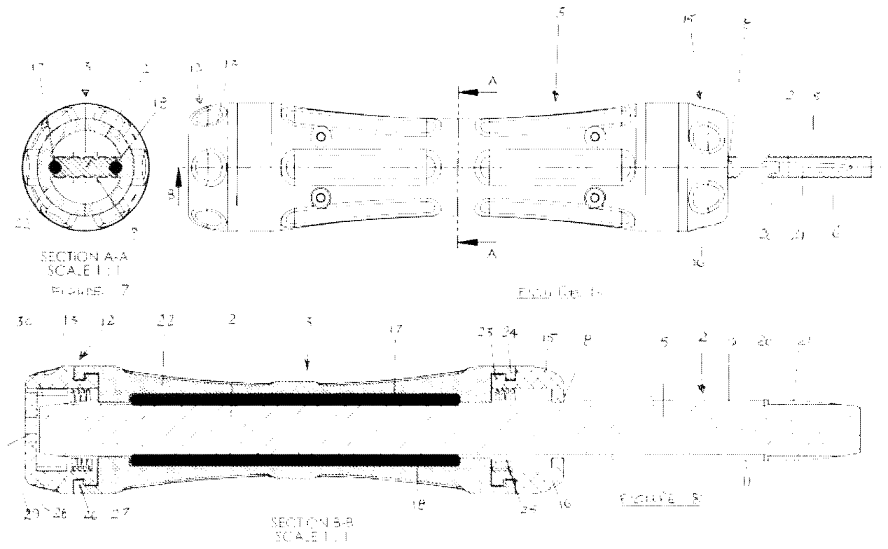

FIG. 3 shows with corresponding numbering a side elevation of the hand tool of FIG. 1. FIG. 4 shows a first end elevation view of the hand tool of FIG. 1.

FIG. 5 shows a second end 15 elevation view of the hand tool 1 of FIG. 1. End 15 of handle 3 includes closure 16 which receives shaft 2 via through passage 8. From this view recesses 9 and 11 can be seen on either side of shaft 2. A keyway is provided in the handle to generally match the adopted profile of the shaft. According to one embodiment, at each end of the handle, is provided a rotatable closure which on rotation misaligns the keyway and shaft profile and contributes to preventing the shaft from exiting the keyway. In the case of the flat file shaft the misalignment is orthogonal. It will be appreciated that a reference to a keyway can be taken to also mean a generic reference to a slot, opening abbreviation, hole, passage, guide, and the like where there exists a co-operation between the shaft and handle.

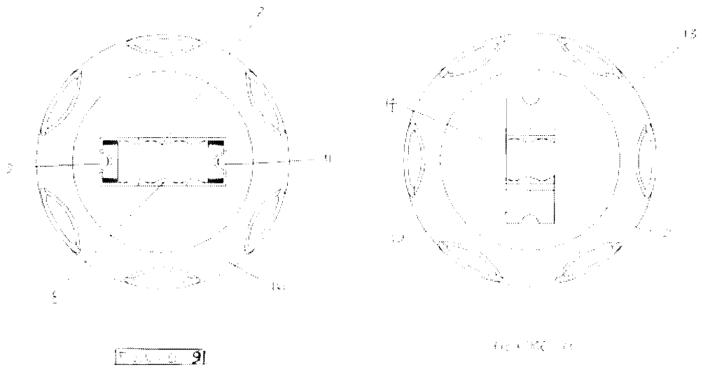

FIG. 6 shows with corresponding numbering, an enlarged elevation view of the handle 2 of hand tool 1. FIG. 7 shows a cross sectional elevation view of the tool of 1 FIG. 6 taken across line A-A through handle 2. FIG. 8 shows a long sectional elevation taken along B-B. Midway through handle 3 shaft 2 has engaged guides 17 and 18 which are retained by inner wall 22 of handle 3 and engage shaft 2 via respective recesses 9 and 11. Guides 17 and 18 enable the shaft to track along through passage 8. End cap 16 is retained by handle 2 via co-operating shoulder formations 23 and 24 which allow end cap 16 to rotate relative to inner wall 22. Bias spring 25 retains the positive fit of cap 16 to wall and provides a bias during rotation of end 16. As shown in FIG. 8, end cap 16 is disposed in an orientation which prevents unwanted extension of shaft 2 through passage 8. Likewise, end cap 13 engages inner wall 2 via shoulders 26 and 27. Bias spring 28 urges cap 13 into a positive engagement with wall 22. As shown end cap 13 presents opening 29 normally to the orientation of end 30 of shaft 2.

FIG. 9 shows with corresponding numbering an enlarged end view of FIG. 5 at the point of entry of shaft into handle. FIG. 10 shows with corresponding numbering an enlarged end view of FIG. 4 at the point of entry of shaft 2 into handle 3.

For convenience, the description herein refers to grip operated hand tools and more specifically to a filing tool which has an abrasive surface of at least one textured surface.

The embodiments previously described are examples only and it will be appreciated by persons skilled in the art that the tool configuration may be adjusted to accommodate different sizes, shapes, geometries, modes of operation, and configurations. For example the filing surface contours may vary along the shaft, may differ from one face to another face and the shaft may have other suitable cross sectional geometrical profiles along either part of its length or over its full length. In certain cases the invention will be adapted to accommodate prescribed requirements and applications. The present invention obviates the disadvantages of the prior art and provides a useful alternative to the known art and other advantages which are apparent from the description herein.

It will be further appreciated that the work tool described herein, can be manufactured with a variety of working end options. For instance, the working surfaces can be selected from a variety of grades and formations. Furthermore, the tool handle can be size adjusted to accommodate the nature of the shaft and the number, shape and type of filing surfaces. For example, the handles can be lengthened to accommodate a larger hand to file shaft length ratio (which is ideally 60% shaft and 40% handle).

It will be appreciated that the above description relates to the preferred embodiment by way of example only. Many variations on the invention will be obvious to those knowledgeable in the field, and such obvious variations are within the scope of the invention as described and claimed, whether or not expressly described. It will be recognised by persons skilled in the art that numerous variations and modifications may be made to the invention described herein without departing from the overall spirit and scope of the invention.

1. A hand operated filing tool comprising a gripping handle, an elongated shaft extending through the handle; the shaft having a first working end including at least one filing surface along at least part of the length of the first working end of the shaft and a second working end including at least one filing surface along at least part of the length of the second working end of the shaft; the shaft and handle arranged to allow the handle to move between the working ends of the shaft, thereby allowing user selection of the at least one filing surface at either the first or second working ends.

2. A filing tool according to claim 1 wherein the handle can be released from the shaft and repositioned on the shaft at the same or opposite end of the shaft.

3. A filing tool according to claim 2 wherein the tool further comprises an arrest mechanism which retains the travel of the shaft relative said handle at a predetermined limit position to enable locking of the shaft against said handle.

4. A filing tool according to claim 3 wherein the arrest mechanism is provided by a shoulder formation which provide an abutment and limits travel of the handle along the shaft to a predetermined stop position.

5. A filing tool according to claim 4 wherein the shaft can be rotated relative to the handle.

6. A filing tool according to claim 5 wherein a keyway is provided in the handle to match the selected profile of the shaft.

7. A filing tool according to claim 6 wherein each end of the handle, is provided a rotatable closure which on rotation misaligns the keyway and shaft profile to prevent the shaft from exiting the keyway.

8. A filing tool according to claim 7 wherein the cross sectional profile shape of the working ends of the shaft when viewed in cross section is selected from at least one of the following profiles; circular, concave, crescent shaped, square, triangular, rectangular, hexagonal, polygonal.

9. A filing tool according to claim 8 wherein the shaft selected has a rectangular profile and includes along at least one side edge a first formation which co-operates with a second formation associated with the handle to enable setting of the shaft in said limit position.

10. A filing tool according to claim 8 wherein, there are multiple filing surfaces provided at each working end.

11. A filing tool according to claim 10 wherein each said filing surfaces lie in different planes on the shaft.

12. A filing tool according to claim 11 wherein there are up to 8 user selectable working surfaces.

13. A filing tool according to claim 12 wherein each working surface has a different grade.

14. A filing tool according to claim 12 wherein each working surface has the same grade.

15. A filing tool according to claim 12 wherein half of the working surfaces have the same grade and the other half of the working surfaces have a different grade.

16. A filing tool according to claim 8 wherein the shaft is circular

17. A filing tool according to claim 16 wherein one said two working ends of the circular shaft has a filing surface of a first texture grade

18. A filing tool according to claim 17 wherein the second end of the circular shaft has a filing surface of a second texture grade

19. A filing tool according to claim 8 wherein the shaft is rectangular having two flat filing surfaces and an aligning guide along its side edges.

20. A filing tool according to claim 19 wherein the filing surfaces each have a fine texture/grade.

21. A filing tool according to claim 19 wherein the filing surfaces each have a coarse texture/grade.

22. A filing tool according to claim 19 wherein one filing surface has a fine texture/grade and the other filing surface has a coarse texture/grade.

23. A filing tool according to claim 8 wherein filing surfaces on a rectangular shaft are crescent shaped.

24. A hand operated filing tool of the type comprising a gripping handle, an elongated shaft extending through the handle and having a first working end and a second working end; the first working end including a filing surface along at least part of the length of the shaft and the second working end including a filing surface along at least part of the length of the shaft; the shaft and handle arranged to allow the handle to move/slide along the shaft between the first and second working ends of the shaft, thereby allowing user selection of either the first or second working ends; the tool further comprising an arrest mechanism which retains the travel of the shaft relative said handle at a predetermined limit position to enable locking of the shaft against said handle.

25. A filing tool according to claim 24 wherein the tool further comprises an arrest mechanism which retains the travel of the shaft relative said handle at a predetermined limit position to enable locking of the shaft against said handle.

26. A filing tool according to claim 25 wherein the arrest mechanism is provided by a shoulder formation which provide an abutment and limits travel of the handle along the shaft to a predetermined stop position.

27. A hand operated filing tool according to claim 26 wherein, the working ends of the shaft when viewed in cross section are selected from at least one of the following profiles; circular, concave, crescent shaped, square, triangular, rectangular, hexagonal, polygonal.

28. A filing tool according to claim 27 wherein the working ends of the shaft have at least one working filing face with a different abrasion grade.

29. A filing tool according to claim 28 wherein the filing surfaces have a rough texture/grade.

30. A filing tool according to claim 28 wherein the filing surfaces have a fine texture/grade.

31. A filing tool according to claim 28 wherein the filing surfaces have a combination of fine and rough texture/grade.
